(19) United States
(12) Patent Application Publication
(10) Pub. No.: US 2002/0017854 A1
(43) Pub. Date: Feb. 14, 2002

(54) ELECTRON EMISSIVE SURFACE AND METHOD OF USE

(76) Inventors: PAUL VON ALLMEN, MESA, AZ (US); JAMES E. JASKIE, SCOTTSDALE, AZ (US); BERNARD F. COLL, FOUNTAIN HILLS, AZ (US)

Correspondence Address: VINCENT B INGRASSIA, MOTOROLA INC, INTELLECTUAL PROPERTY DEPARTMENT, SUITE R3108 P O BOX 10219, SCOTTSDALE, AZ, 852710219

(21) Appl. No.: 09/264,295

(22) Filed: Mar. 8, 1999

(51) Int. Cl. H01J 63/04

(52) U.S. Cl. 313/495

(57) ABSTRACT

A field emission device (200) includes a structure (205) with surface material (220) having surface states, where surface states provide resonant tunneling emission of electrons (260) upon application of an electric field (250). Surface states can include edge termination states (230), which include zigzag edges (240) and armchair edges (215).

### FIELD OF THE INVENTION

The present invention relates to the area of electron emissive surfaces, and more particularly, to the structure and use of emissive surfaces in field emission devices.

### BACKGROUND OF THE INVENTION

Several materials are known in the art which are useful for providing electron emission in vacuum devices such as field emission devices. These prior art field emissive materials include metals such as molybdenum, and semiconductors such as silicon or carbon. However, the gate extraction voltage required for electron emission from these materials is relatively high. High gate extraction voltage operation is undesirable because charged ions discharged at the electron receiving material are accelerated to high velocities, thereby exacerbating damage caused by the bombardment by these ions on elements of the device. Also, higher gate extraction voltages require greater power consumption for a given current density.

Accordingly, there exists a need for an improved electron emissive surface, which has low gate extraction voltage requirements.

### BRIEF DESCRIPTION OF THE DRAWINGS

FIG. 1 is a cross-sectional view of a structure with surface material containing edge termination states;

FIG. 2 shows an atomic structure;

FIG. 3 shows an emissive cluster of an electron-emissive film;

FIG. 4 is an edge view of the electron-emissive film of FIG. 3, taken along the section line 4-4;

FIG. 5 is a graphical representation of electron emission current versus average electric field;

FIG. 6 is a graphical representation of a current voltage characteristic for an electron-emissive film;

FIG. 7 illustrates a deposition apparatus useful for making an electron-emissive film; and

FIG. 8 is a cross-sectional view of an embodiment of a field emission device.

It will be appreciated that for simplicity and clarity of illustration, elements shown in the FIGS. have not necessarily been drawn to scale. For example, the dimensions of some of the elements are exaggerated relative to each other. Further, where considered appropriate, reference numerals have been repeated among the figures to indicate corresponding elements.

### DESCRIPTION OF THE PREFERRED EMBODIMENT

An embodiment of the invention is for a field emission device having an emissive surface with surface states and method of emitting electrons from emissive surface, which causes resonant tunneling emission of electrons. The emissive surface with surface states provides numerous benefits. For example, a lower gate extraction voltage is required for a given emission current. The lower gate extraction voltage required provides for a reduction in the power consumption of the field emission device and avoids the discharge of contaminating ions associated with higher gate extraction voltages.

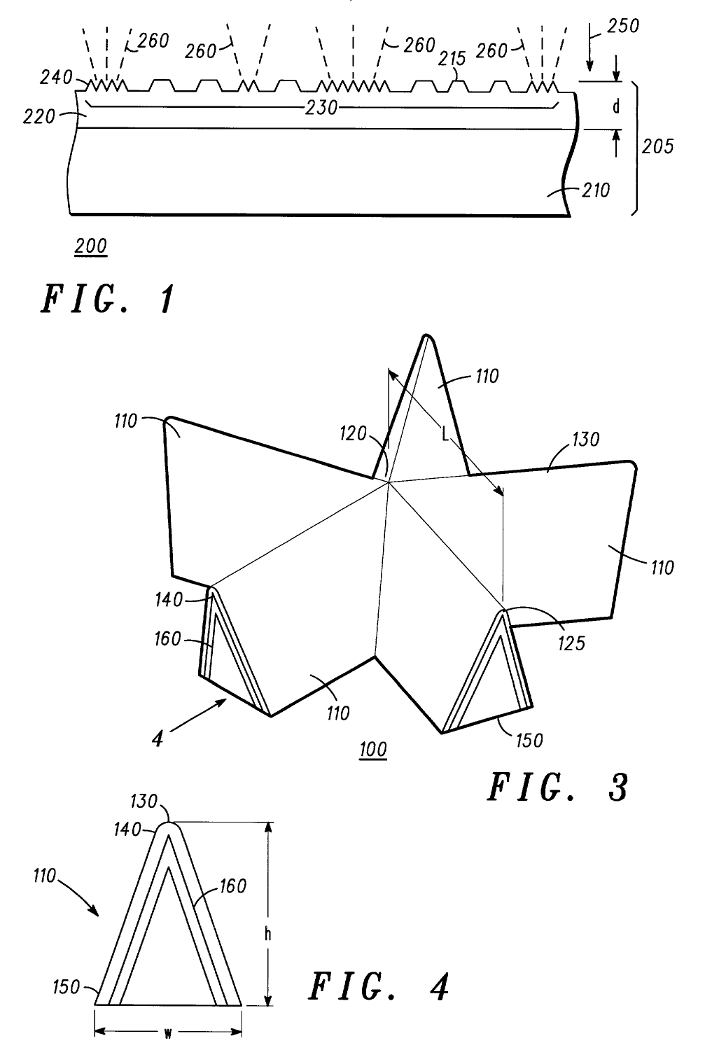

FIG. 1 is a cross-sectional view of a field emission device 200 containing a structure 205 with a surface material 220. Structure 205 contains a bulk material 210 disposed below surface material 220. Surface material 220 has a thickness (d) that is less than 100 angstroms and contains sp² bonded or sp² like bonded atoms such as carbon, boron, nitrogen, and the like. Surface material 220 also contains surface states. Surface states can include edge termination states 230. Edge termination states 230 arise from a specific arrangement of atoms within surface material 220, which lead to a localized electronic state than enhances resonant tunneling emission of electrons 260 in the presence of an electric field 250.

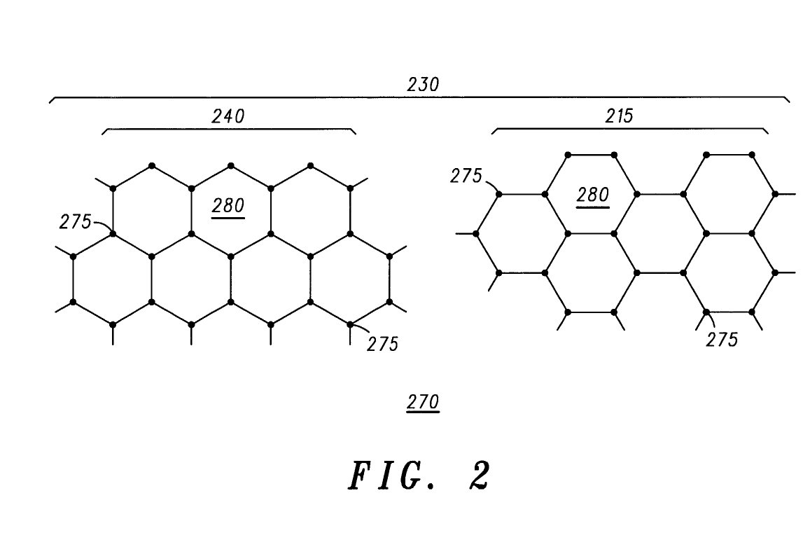

FIG. 2 shows an atomic structure 270 where atoms 275 have a hexagonal lattice structure 280 that have edge termination states 230. Atoms 275 can be carbon, boron, nitrogen, or any atoms bonded by sp² bonds or sp² like bonds. Edge termination states 230 can have zigzag edges 240 or armchair edges 215.

Referring to FIG. 1, edge termination states 230 can be an irregular pattern of zigzag edges 240 and armchair edges 215, although this is not a limitation of the present invention. When hexagonal lattice structure 280 is present, resonant tunneling emission of electrons 260 occurs in portions of edge termination states 230 that contain zigzag edges 240 and not in those that contain armchair edges 215. Theoretical support for the existence of zigzag edges 240 and armchair edges 215 can be found in “Edge State In Graphene Ribbons: Nanometer Size Effect And Edge Shape Dependence” by K. Nakada, et al., Physical Review B, The American Physical Society, vol. 54, no. 24, Dec. 15, 1996.

FIG. 3 shows an emissive cluster 100 of an electron-emissive film. Emissive cluster 100 contains structure 205 having surface material 220 with edge termination states 230 (see FIG. 1). Electron-emissive film has a uniform distribution of emissive clusters, such as emissive cluster 100. These emissive clusters largely define the surface morphology of electron-emissive film.

As illustrated in FIG. 3, emissive cluster 100 is generally star-shaped and has a plurality of dendrites or dendritic platelets 110, each of which extends generally radially from a central point 120. The configuration of emissive cluster 100 of FIG. 3 is representative of emissive clusters, but the exact number and configuration of the dendrites is not limited to that shown in FIG. 3.

Each dendrite 110 has a narrow end 140 and a broad end 150. At narrow end 140, each dendrite 110 has a ridge 130, which extends along the length (L) of dendrite 110. The length (L) of dendrite 110 extends from central point 120 to a terminal end 125 and for example ranges from 50-400 nanometers (nm). Preferably, the length (L) of dendrite 110 is about 200 nm. Ridge 130 has a radius of curvature, which is less than 10 nm, preferably less than 2 nm. Ridge 130 contains structure 205 having surface material 220 and edge termination states 230 as shown in FIGS. 1 and 2.

FIG. 4 is an edge view of the electron-emissive film of FIG. 3, taken along the section lines 4-4. Each of dendrites 110 has a transverse height (h), which is equal to the distance between broad end 150 and narrow end 140. The height (h) is preferably about 100 nm. Each of dendrites 110 extends from broad end 150 to narrow end 140 in a direction away from the plane of the electron-emissive film. This configuration results in electrons being emitted in a direction away from the plane of the electron-emissive film. A width of dendrite 110 at broad end 150 is labled w, and equal to about 7 nm.

Electron-emissive film of FIGS. 3 and 4 further have a plurality of sheets 160. Sheets 160 have spacing within a range of 0.342-0.350 nm. Sheets 160 extend from broad end 150 to narrow end 140 to define dendrite 110. The upper sections of sheets 160 contain atomic structure 270 as shown in FIG. 2.

In an alternate embodiment, the electron-emissive film can be composed of boron and nitrogen. Further, the boron and nitrogen can be doped with carbon. In particular, electron-emissive film can be turbostratic boron and nitrogen doped with carbon, or alternatively, turbostratic boron and nitrogen doped with some other element that, when included in the film, can make the film electrically conductive.

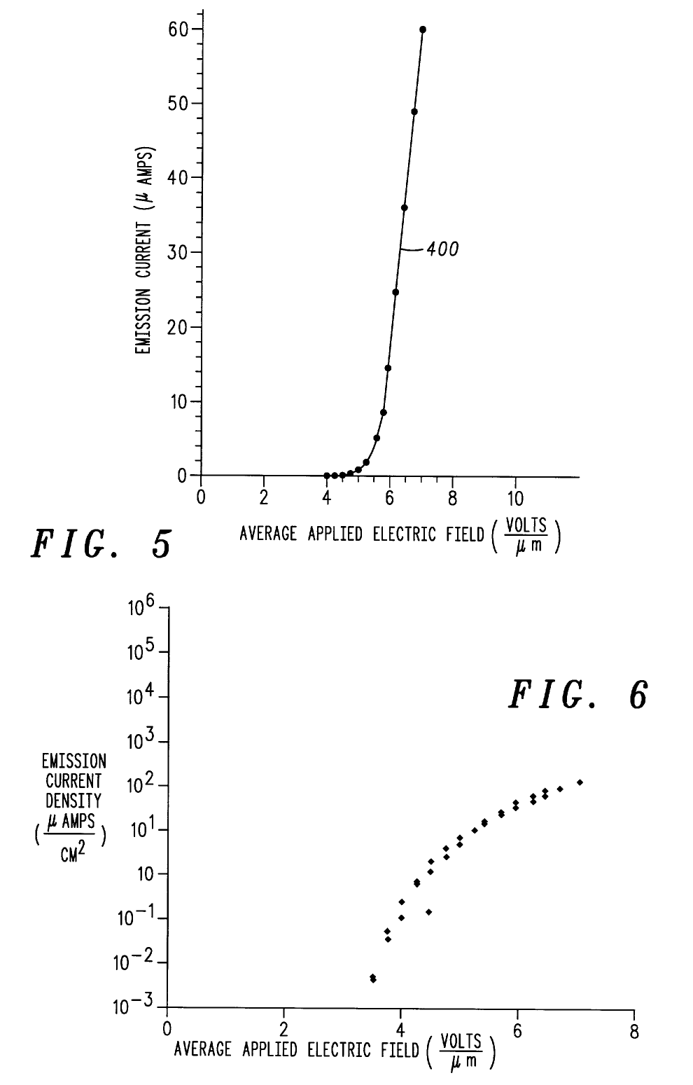

FIG. 5 is a graphical representation 400 of emission current versus average applied electric field for an electron-emissive film with emissive clusters 100. The horizontal axis is average applied electric field in volts per micrometer (V/μm), and the vertical axis is emission current in microamps (IA). The range of average applied electric fields, over which the electron-emissive film becomes emissive, has a range of about 4-7 V/μm. Because the activation and deactivation of electron emission requires switching over a narrow range of electric field strengths, a field emission device utilizing the electron-emissive film with emissive clusters 100 has power consumption requirements and driver costs that are lower than those of the prior art.

FIG. 6 is a graphical representation of emission current density versus average applied electric field for electron-emissive film with emissive clusters 100. The horizontal axis is average applied electric field in V/μm, and the vertical axis is emission current density in microamps per square centimeter (μA/cm²). Those skilled in the art will recognize the plot as suggestive of tunneling phenomena. At higher emission currents and average applied electric fields, emission current increases more slowly than predicated by the Fowler-Nordheim tunneling equation. This is consistent with resonant tunneling emission of electrons 260.

Electron-emissive film, which contains emissive clusters 100, is deposited as a blanket film on a silicon substrate. After electron-emissive film is formed on the silicon substrate, a current meter (a pico-ammeter) is connected to electron-emissive film. An anode is positioned parallel to electron-emissive film. The anode is made from a plate of glass, upon which is deposited a patterned layer of indium tin oxide (ITO). A phosphor made from zinc oxide is electro-deposited onto the patterned ITO. The distance between the anode and electron-emissive film is 0.200 mm. A voltage source is connected to the anode. The pressure within the apparatus is about 10⁻⁶ Torr.

The data points of the emission current response of FIGS. 5 and 6 are generated as follows. First, a potential of zero Volts is applied to the anode, and the emission current is measured using the pico-ammeter connected to the cathode. Then, the potential at the anode is increased by +50 Volts, and the current is again measured at the cathode. The potential at the anode is increased by +50 Volt increments, until a voltage of 1400 Volts is reached. At each voltage increment, the emission current is measured at the cathode. The potential at electron-emissive film is maintained at zero Volts for all measurements. The average electric field is given by the ratio of: (1) the difference between the potentials at electron-emissive film and the anode and (2) the distance between electron-emissive film and the anode. The emission area of electron-emissive film is equal to the portion of the total area of electron-emissive film, from which the measured current is extracted. The emission area is defined as being equal to the area of overlap of electron-emissive film with the opposing anode area. In the particular example of FIGS. 5 and 6 the emission area, as defined by the overlap area, is equal to 0.45 cm².

The scope of the invention is not limited to emissive cluster 100 described above. The invention can be embodied by any field emission device 200 having a structure 205 with a surface 220 including an atomic structure 270 having edge termination states 230.

FIG. 7 is a schematic representation of a deposition apparatus 300 useful for making an embodiment of the invention. Deposition apparatus 300 is an electric arc vapor deposition system. It is emphasized that FIG. 7 is only a diagrammatic representation of such a system, which illustrates those basic portions of an electric arc vapor deposition system that are relevant to a discussion of the present invention, and that such diagram is by no means complete in detail. For a more detailed description of electric arc vapor deposition systems and various portions thereof, one may refer to the following U.S. Pat. No. 3,393,179 to Sablev, et al., U.S. Pat. No. 4,485,759 to Brandolf, U.S. Pat. No. 4,448,799 to Bergman, et al., and U.S. Pat. No. 3,625,848 to Snaper. To the extent than such additional disclosure is necessary for an understanding of this invention, the disclosures and teachings of such patents are hereby incorporated by reference.

Deposition apparatus 300 includes a vacuum chamber 305, which defines an interspace region 310. A deposition substrate 330 is disposed at one end of interspace region 310. Deposition substrate 330 can be made from silicon, soda lime glass, borosilicate glass, and the like. A thin film of aluminum and/or amorphous silicon can be deposited on the surface of the substrate. At an end opposite to substrate 330 within interspace region 310 is a deposition source 320, which is used to generate a deposition plasma 370. The deposition surface of deposition substrate 330 is located along a line-of-sight from deposition source 320. Vacuum chamber 305 further includes a duct portion 335, around which copper coils are wound to form a simple electromagnet 360. A first voltage source 325 is connected to deposition source 320. A second voltage source 380 is connected to deposition substrate 330.

First voltage source 325 is used to form an electric arc at deposition source 320. The electric arc operates on deposition source 320 to vaporize it and form deposition plasma 370. Deposition source 320 is electrically biased to serve as a cathode. An arc-initiating trigger element (not shown) is positioned proximate to deposition source 320 and is positively biased with respect to deposition source 320, so that it serves as an anode. The trigger element is momentarily allowed to engage the surface of deposition source 320, establishing a current flow path through the trigger and deposition source 320. As the trigger element disengages from deposition source 320, an electrical arc forms between the electrodes. Homogeneity of the deposited film is improved by applying a magnetic field with electromagnet 360 for controlling the movement of the arc over the surface of deposition source 320.

Electron-emissive film is formed using deposition apparatus 300. A hydrogen carrier gas is introduced into interspace region 310 to provide a pressure within interspace region 310 of about 1 Torr. Deposition substrate 330 is a silicon wafer. Deposition source 320 is a piece of high-purity, nuclear-grade graphite having a purity within a range of 99.999-100 percent graphite. The distance between deposition source 320 and deposition substrate 330 is about 10 cm. The magnetic field strength at the source for electromagnet 360 is about 0.03 Tesla. The current of the electric arc is about 100 amperes. Second voltage source 380 provides an induced DC voltage of about 100 Volts at deposition substrate 330. Deposition substrate 330 is cooled using a hollow copper plate (not shown), through which water flows, maintaining a substrate temperature of about 100 degrees Centigrade (° C.). This temperature is compatible with substrate materials, such as soda lime glass, which is used in the fabrication of field emission devices. Using the deposition conditions described above, a electron emissive film including emissive clusters 100 having a thickness of about 0.15 μm is deposited on deposition substrate 330.

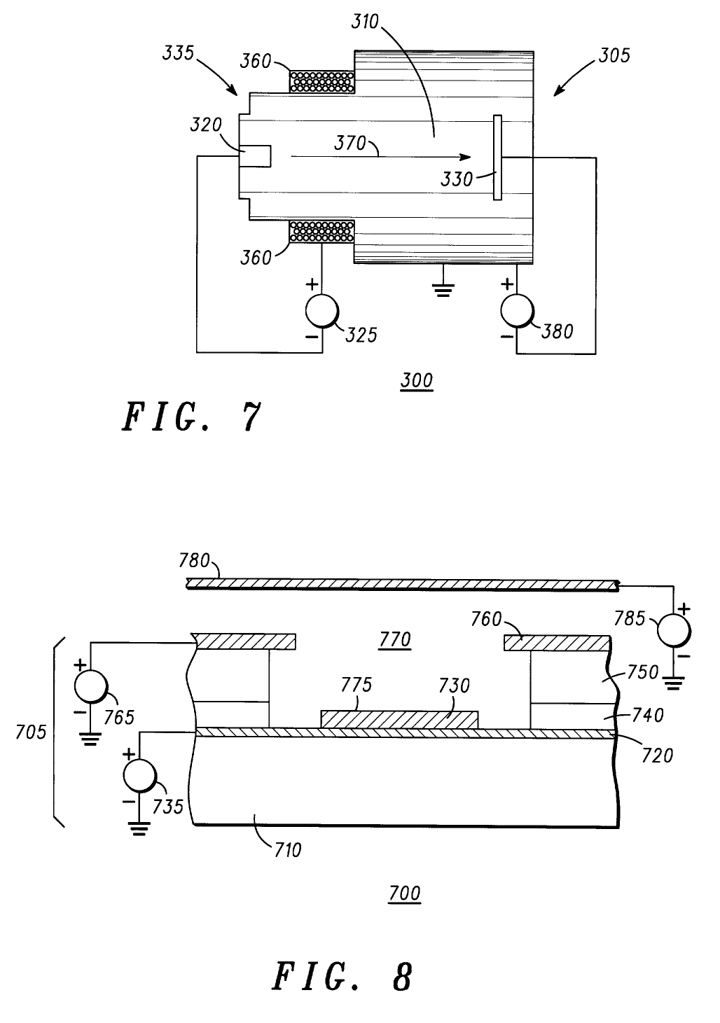

FIG. 8 is a cross-sectional view of an embodiment of a field emission device (FED) 700. FED 700 includes a cathode 705 and an anode 780, which is disposed in spaced relationship to cathode 705. Cathode 705 has an electron-emissive film 730. It is desired to be understood that the use of the electron-emissive film is not limited to that described with reference to FIG. 8.

Cathode 705 is made by first providing a supporting substrate 710, which is made from a suitable material, such as glass, silicon, or the like. A conductive layer 720 is deposited on supporting substrate 710 using standard deposition techniques. Then, a field shaper layer 740 is deposited on conductive layer 720. Field shaper layer 740 is made from a doped silicon. The dopant can be boron, and an exemplary dopant concentration is 10¹⁸ dopant species per cm³. Thereafter, a dielectric layer 750 is formed on field shaper layer 740. Dielectric layer 750 can be made from silicon dioxide. A gate extraction electrode layer 760, which is made from a conductor such as, molybdenum, is deposited onto dielectric layer 750. An emitter well 770 is formed by selectively etching into layers 760, 750, 740. Emitter well 770 has a diameter of about 4 micrometers (μm) and a depth of about 1 μm.

The etched structure is then placed within a cathodic arc deposition apparatus, and electron-emissive film 730 is deposited, in the manner described with reference to FIG. 7. Electron-emissive film 730 is selectively deposited, as by using a mask, onto conductive layer 720 within emitter well 770. The thickness of electron-emissive film 730 is preferably between 0.01-0.5 μm.

A first voltage source 735 is connected to conductive layer 720. A second voltage source 765 is connected to gate extraction electrode layer 760. A third voltage source 785 is connected to anode 780. The operation of FED 700 includes applying suitable potentials from voltage sources 735, 765 and 785 at conductive layer 720, gate extraction electrode layer 760, and anode 780. Electrons are extracted from an emissive surface 775 of electron-emissive film 730 and travel to anode 780. Field shaper layer 740 aides in shaping the electric field in the region of emissive surface 775.

It should be understood that the invention is not limited to the electron-emissive film 730 shown in FED 700. Other electron emissive structures can be used in FED 700. For example, Spindt tips, metallic nanoprotrusions, nanotubes, and the like, that contain structure 205 having a surface material 220 which includes an atomic structure 270 having edge termination states 230 are considered within the scope of the invention.

A method for emitting electrons includes the step of applying an electric field 250 to a structure 205. Structure 205 has a surface material 220 which includes an atomic structure 270 having edge termination states 230, which cause resonant edge tunneling emission of electrons 260. Thereafter, conducting electrons through bulk material 210 that is disposed below surface material 220 of structure 205. Thereafter, establishing a resonant tunneling energy level within the range of 2 electron volts above and 15 electron volts below the Fermi energy level of the emitter material, although this range is not a limitation of the present invention.

In summary, an embodiment of the invention is for a field emission device having an emissive surface with edge termination states and method of emitting electrons from emissive surface, which causes resonant tunneling emission of electrons.

It should now be understood that the emissive surface with surface states provides numerous advantages such as lowering the gate extraction voltage required for a given emission current. This reduces the operating cost of a field emission device and avoids the discharge of contaminating ions associated with higher gate extraction voltages.

1. A field emission device, comprising:
a cathode having a structure having a surface material which includes an atomic structure having surface states, wherein the surface states are comprised of edge termination states, wherein the edge termination states provide a resonant tunneling emission of electrons upon application of an electric field;
a gate extraction electrode positioned proximate to the surface material and configured to apply the electric field to the edge termination states; and
an anode disposed in spaced relationship to the cathode and configured to receive the resonant tunneling emission of electrons emitted from the edge termination states.

2. The field emission device of claim 1, wherein the surface material has a thickness of less than 100 angstroms.

3. The field emission device of claim 1, wherein the edge termination states are disposed within the surface material.

4. The field emission device of claim 1, wherein the edge termination states are arranged in an irregular pattern.

5. The field emission device of claim 1, wherein the edge termination states are comprised of zigzag edges.

6. The field emission device of claim 1, wherein the edge termination states include a plurality of sp² bonded atoms.

7. The field emission device of claim 6, wherein the plurality of sp² bonded atoms are comprised of carbon.

8. The field emission device of claim 6, wherein the plurality of sp² bonded atoms are comprised of boron and nitrogen.

9. The field emission device of claim 6, wherein the plurality of sp² bonded atoms are comprised of carbon, boron and nitrogen.

10. A field emission device, comprising:
a structure having a surface material which includes an atomic structure having surface states; and
wherein the surface states are comprised of edge termination states, and wherein the edge termination states provide a resonant tunneling emission of electrons upon application of an electric field.

11. The field emission device of claim 10, wherein the surface material has a thickness of less than 100 angstroms.

12. The field emission device of claim 10, wherein the edge termination states are disposed within the surface material.

13. The field emission device of claim 10, wherein the edge termination states are arranged in an irregular pattern.

14. The field emission device of claim 10, wherein the edge termination states are comprised of zigzag edges.

15. The field emission device of claim 10, wherein the edge termination states include a plurality of sp² bonded atoms.

16. The field emission device of claim 15, wherein the plurality of sp² bonded atoms are comprised of carbon.

17. The field emission device of claim 15, wherein the plurality of sp² bonded atoms are comprised of boron and nitrogen.

18. The field emission device of claim 15, wherein the plurality of sp² bonded atoms are comprised of carbon, boron and nitrogen.

19. A method of emitting electrons, comprising the steps of:
providing a structure having a surface material which includes an atomic structure having surface states, wherein the surface states are comprised of edge termination states; and
applying an electric field which causes a resonant tunneling emission of electrons.

20. The method of claim 19, further comprising the step of conducting electrons through a bulk material disposed below the surface material.

21. The method of claim 20, further comprising the step of establishing a resonant tunneling energy level substantially within the range of 2 electron volts above and 15 electron volts below a Fermi energy level.
